(19) United States
(12) Patent Application Publication
(10) Pub. No.: US 2007/0183338 A1
(43) Pub. Date: Aug. 9, 2007

(54) Method and apparatus for detecting interference in a wireless communication system

(76) Inventors: Manoneet Singh, Santa Clara, CA (US); David S. Propach, Saratoga, CA (US)

Correspondence Address: QUALCOMM INCORPORATED, 5775 MOREHOUSE DR., SAN DIEGO, CA, 92121, US

(21) Appl. No.: 11/499,199

(22) Filed: Aug. 3, 2006

Related U.S. Application Data
(60) Provisional application No. 60/765,982, filed on Feb. 6, 2006.

(51) Int. Cl. H04J 1/16; H04L 12/56

(52) U.S. Cl. 370/252; 370/401

(57) ABSTRACT

Techniques for classifying RF channels in a first system (e.g., a Bluetooth system) to mitigate the deleterious effects of interference from a second system (e.g., a WLAN system) are described. One or more metrics (e.g., PER and/or RSSI) are determined for the RF channels. Each RF channel may be classified as good or bad based on the metric(s) for that RF channel. Whether excessive interference is observed on any frequency channel for the second system is determined based on the metric(s) for the RF channels. Excessive interference may be declared if the average PER for RF channels overlapping a frequency channel exceeds a threshold TH_{W} or if the number of bad RF channels within the frequency channel exceeds a threshold TH_{C}. A set of usable RF channels is formed and includes good RF channels not overlapping any frequency channel with excessive interference.

The present application claims priority to provisional U.S. Application Ser. No. 60/765,982, entitled “Method for Interference Detection in a Frequency Hopping System,” filed Feb. 6, 2006, assigned to the assignee hereof and incorporated herein by reference.

### BACKGROUND

I. Field

The present disclosure relates generally to communication, and more specifically to techniques for detecting interference in a wireless communication system.

II. Background

Wireless communication systems are widely deployed to provide wireless communication and wireless connectivity for various electronic devices. These wireless systems include wireless personal area network (WPAN) systems, wireless local area network (WLAN) systems, and so on. Many wireless systems operate in the 2.4 giga Hertz (GHz) band, which has become popular due to the de-licensing of the Industrial, Scientific, and Medical (ISM) frequency bands.

Many WPAN systems implement Bluetooth, which is a short-range radio technology. Bluetooth can provide wireless interconnectivity between electronic devices such as cellular phones and headsets, personal computers (PCs) and peripheral devices such as mice and keyboards, and so on. Bluetooth is adopted as IEEE 802.15 standard, which is publicly available. Bluetooth eliminates the need for wired connection and is becoming more popular. Hence, the number of Bluetooth devices is expected to increase dramatically in the coming years.

Many WLAN systems implement IEEE 802.11, which is a family of standards for medium-range radio technologies. IEEE 802.11 includes 802.11, 802.11a, 802.11b, and 802.11g. 802.11 supports data rates of 1 and 2 mega bits/second (Mbps) in the 2.4 GHz band using either frequency hopping spread spectrum (FHSS) or direct sequence spread spectrum (DSSS). 802.11b uses DSSS to support data rates of up to 11 Mbps in the 2.4 GHz band. 802.11g supports data rates of up to 54 Mbps in the 2.4 GHz band using orthogonal frequency division multiplexing (OFDM). These various IEEE 802.11 standards are publicly available. A WLAN system may implement any one or any combination of IEEE 802.11 standards, e.g., 802.11b and 802.11g, which are often denoted as 802.11b/g. A WLAN system supports wireless communication between various electronic devices such as personal computers, laptops, cellular phones, and so on. The number of WLAN systems is also expected to increase dramatically in the coming years.

Bluetooth systems, WLAN systems, and/or other wireless systems may be deployed within close proximity of one another, e.g., within office buildings, homes, and so on. If these wireless systems operate on the same frequency band, then the transmissions for one system may cause interference to the transmissions for other systems. The interference may adversely impact the performance of all affected systems.

There is therefore a need in the art for techniques to detect and mitigate interference so that multiple wireless systems can co-exist on the same frequency band.

### SUMMARY

Techniques for classifying radio frequency (RF) channels in a first communication system (e.g., a Bluetooth system) to mitigate the deleterious effects of interference from a second communication system (e.g., a WLAN system) are described herein. According to an embodiment, an apparatus is described which includes at least one processor and a memory. The processor(s) determine at least one metric (e.g., packet error rate (PER), received signal strength indication (RSSI), and so on) for the RF channels in the first system. The processor(s) determine whether excessive interference is observed on any frequency channel for the second system based on the at least one metric for the RF channels in the first system. The processor(s) then form a set of usable RF channels for the first system. This set excludes RF channels that overlap any frequency channel with excessive interference. By using the set of usable RF channels for the first system, interference between the first and second systems is avoided, and both systems can operate on the same frequency band.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 shows a deployment of a Bluetooth system and a WLAN system.

FIG. 2 shows spectral plots of WLAN frequency channels 1, 6 and 11.

FIG. 3 illustrates frequency hopping for a 79-hop Bluetooth system.

FIG. 4 shows a process for operating the Bluetooth system with adaptive frequency hopping.

FIG. 5 shows a process for classifying Bluetooth RF channels based on PER.

FIG. 6 shows a process for classifying Bluetooth RF channels based on the number of bad RF channels.

FIG. 7 shows a process for classifying Bluetooth RF channels based on PER and RSSI.

FIG. 8 shows a block diagram of a wireless device.

FIG. 9 shows a frequency hopping unit at the wireless device.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

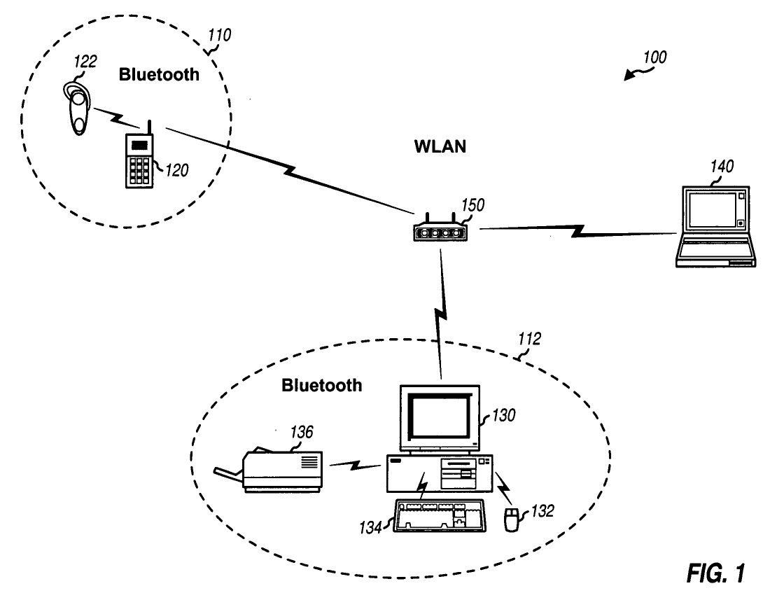

FIG. 1 shows an exemplary deployment 100 of a Bluetooth system and a WLAN system. The Bluetooth system supports short-range radio communication between a wireless device 120 and a headset 122, which form a piconet 110. The Bluetooth system also supports short-range radio communication between a personal computer 130, a mouse 132, a keyboard 134, and a printer 136, which form a piconet 112. A piconet is a collection of Bluetooth devices sharing a common frequency-hopping channel. In general, the Bluetooth system may include any number of piconets and any number of devices communicating via Bluetooth. Different power classes are available for Bluetooth devices, with Class 2 Bluetooth devices having a transmission range of 10 meters and Class 3 Bluetooth devices having a transmission range of 100 meters.

The WLAN system supports medium-range radio communication between an access point 150, wireless device 120, personal computer 130, and a laptop computer 140. In general, the WLAN system may include any number of access points that support wireless communication for any number of devices. WLAN devices may also communicate directly with each other via peer-to-peer communication. The WLAN system may implement 802.11b and/or 802.11g and may operate in the same 2.4 GHz band as the Bluetooth system.

802.11b and 802.11g divide the frequency spectrum from 2400 to 2495 mega Hertz (MHz) into 14 staggered and overlapping frequency channels, which are numbered as channels 1 through 14. These frequency channels are also referred to as WLAN channels and WLAN frequency channels in the following description. Each WLAN frequency channel has a 3 decibel (dB) bandwidth of 22 MHz. WLAN frequency channel 1 has a center frequency of 2412 MHz, WLAN frequency channels 2 through 13 have center frequencies that are successively 5 MHz higher, and WLAN frequency channel 14 has a center frequency of 2484 MHz. WLAN frequency channels 1 through 13 have center frequencies that are 5 MHz apart, and WLAN frequency channel 14 has a center frequency that is 10 MHz higher than the center frequency of WLAN frequency channel 13. Not all WLAN frequency channels may be available for use. For example, only WLAN frequency channels 1 through 11 are available for use in the United States.

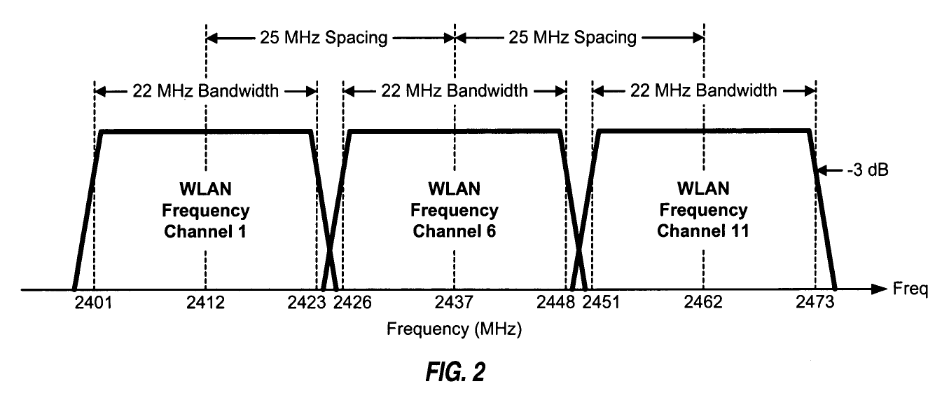

FIG. 2 shows spectral plots of WLAN frequency channels 1, 6 and 11, which are commonly used for 802.11b and 802.11g. WLAN frequency channels 1, 6 and 11 have center frequencies of 2412, 2437 and 2462 MHz, respectively, and are spaced apart by 25 MHz. Since each WLAN frequency channel has a 3 dB bandwidth of 22 MHz, the passbands of WLAN frequency channels 1, 6 and 11 do not overlap one another. Hence, it is possible to operate on all three WLAN frequency channels 1, 6 and 11 in the same geographic area, which makes these WLAN frequency channels popular for many WLAN deployments.

Bluetooth can operate in the 2.4 GHz band either from 2400 to 2483.5 MHz (which is called the full Bluetooth band) or from 2446.5 to 2483.5 MHz (which is called the limited Bluetooth band). The full Bluetooth band is applicable for most countries including the United States and is divided into 79 RF channels that are given indices of 0 through 78. The limited Bluetooth band is applicable for France and is divided into 23 RF channels that are given indices of 0 through 22. Each RF channel is 1 MHz wide. These RF channels are also referred to as Bluetooth channels and Bluetooth RF channels in the following description. The center frequencies for the 79 Bluetooth RF channels in the full Bluetooth band may be given as:

fₖ=2402+k MHz, for k=0, . . . , 78. Eq (1)

The center frequencies for the 23 Bluetooth RF channels in the limited Bluetooth band may be given as:

fₖ=2454+k MHz, for k=0, . . . , 22. Eq (2)

Bluetooth employs frequency hopping so that a transmission hops across the Bluetooth RF channels in different time slots. Each time slot is 625 microseconds (μs) in duration for Bluetooth. A 79-hop system is used for the full Bluetooth band, and a 23-hop system is used for the limited Bluetooth band. For clarity, the following description is for the full Bluetooth band.

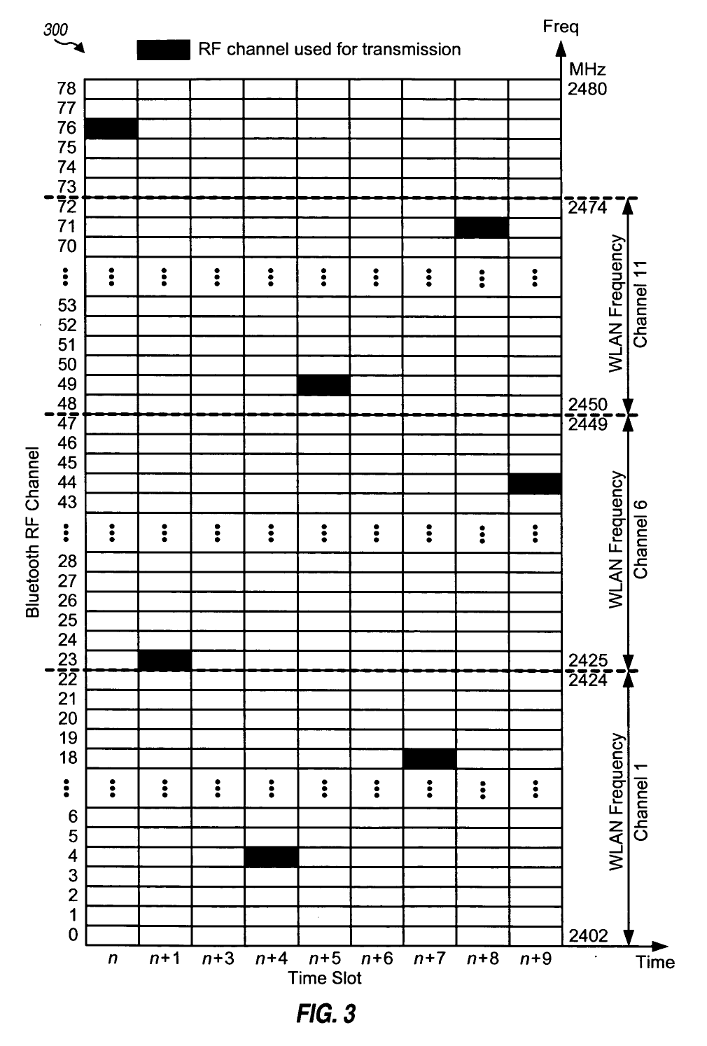

FIG. 3 illustrates frequency hopping on a time-frequency plane 300 for one piconet in a 79-hop Bluetooth system. The piconet includes a master device and up to 7 actively communicating slave devices. The piconet is associated with a unique hopping sequence that is generated based on a pseudo-random algorithm defined by Bluetooth and with a unique address for the master device. The hopping sequence indicates a specific Bluetooth RF channel to use in each time slot. Since each time slot is 625 μs, the Bluetooth RF channel used for transmission changes at a rate of 1600 times per second. The hopping sequence is designed to be random, to not show repetitive patterns over a short time interval, to hop equally across the Bluetooth RF channels over a short time interval, and to repeat over a very long time period.

FIG. 3 also shows the overlap in the operating frequencies of the Bluetooth system and the WLAN system. The Bluetooth system may hop across the entire 2.4 GHz band from 2402 to 2480 MHz. The WLAN system may operate on WLAN frequency channel 1, 6, 11, or some other WLAN frequency channel available for 802.11b and 802.11g. Table 1 lists the three WLAN frequency channels 1, 6 and 11, the range of frequencies for each WLAN frequency channel, and the Bluetooth RF channels that overlap with each WLAN frequency channel. The frequency range and the overlapping Bluetooth RF channels for each of the other WLAN frequency channels may be determined in similar manner.

TABLE 1

| WLAN | | Bluetooth |
|---|---|---|
| Frequency Channel | Frequency Range | RF Channels |
| 1 | 2402 to 2424 MHz | 0 to 22 |
| 6 | 2425 to 2449 MHz | 23 to 47 |
| 11 | 2450 to 2474 MHz | 48 to 72 |

If the Bluetooth system and the WLAN system operate in the same frequency band, then each system may cause interference to the other system, and the performance of both systems may be degraded. The interference may be especially severe for devices that can simultaneously operate on both the Bluetooth system and the WLAN system, e.g., wireless device 120 and personal computer 130 in FIG. 1.

Bluetooth uses adaptive frequency hopping (AFH) to mitigate the deleterious effects of interference resulting from the Bluetooth system and the WLAN system being in close proximity with one other and operating on the same frequency band. With adaptive frequency hopping, Bluetooth RF channels that are prone to high levels of interference are excluded from use, and the hopping sequence selects only the good Bluetooth RF channels for data transmission. Adaptive frequency hopping allows both the Bluetooth system and the WLAN system to co-exist on the same frequency band and achieve satisfactory performance.

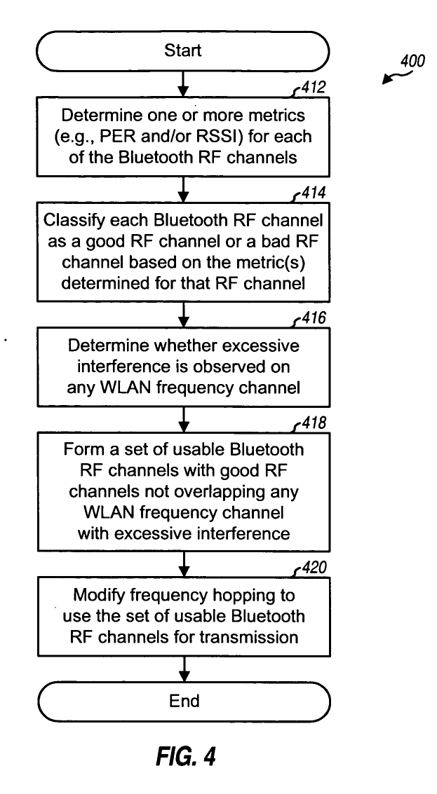

FIG. 4 shows an embodiment of a process 400 for operating the Bluetooth system with adaptive frequency hopping. Process 400 may be performed by a Bluetooth device in a piconet.

Initially, one or more metrics are determined for each of the Bluetooth RF channels (block 412). The metric(s) may include packet error rate (PER), received signal strength indication (RSSI), and so on. Each Bluetooth RF channel may be classified as either a good RF channel or a bad RF channel based on the metric(s) determined for that Bluetooth RF channel (block 414). The process of classifying the Bluetooth RF channels as good or bad is referred to as channel classification and may be performed as described below.

Whether excessive interference is observed on any WLAN frequency channel is determined (block 416). This determination may be made based on the metric(s) obtained for the Bluetooth RF channels, as described below. A set of usable Bluetooth RF channels is then formed (block 418). This set contains good RF channels not overlapping (i.e., not within) any WLAN frequency channel with excessive interference. The frequency hopping for the piconet is then modified to use the set of usable Bluetooth RF channels for transmission (block 420). The set of usable Bluetooth RF channels, the modified hopping sequence, and/or other pertinent information may be exchanged among all Bluetooth devices in the piconet so that these devices transmit using the modified hopping sequence.

Blocks 412 through 418 may be performed by any Bluetooth device in the piconet. For example, a slave device may perform the channel classification and may send the classification information to the master device. The master device may also perform the channel classification. The master device may autonomously select the final set of usable Bluetooth RF channels based on its classification information. The master device may also select the final set of usable Bluetooth RF channels based on the classification information collected by the master device and the slave device(s).

The channel classification may be performed based on various metrics such as PER, RSSI, and so on. PER is a ratio of the number of packets received in error to the number of packets sent. A packet is a group of bits that may be sent in one, three, or five time slots with Bluetooth. Each packet includes a cyclic redundancy check (CRC) value that allows a receiving device to determine whether the packet was decoded correctly or in error. Bluetooth RF channels that are prone to interference typically exhibit high PERs. The PERs for individual Bluetooth RF channels may be ascertained over a certain period of time. Bluetooth RF channels with high PERs may be deemed as bad RF channels.

RSSI is a measure of received signal strength or received power. RSSI may be used in various manners for channel classification. For example, RSSI may be used in combination with PER to determine whether a given Bluetooth RF channel is good or bad. If a packet error is detected and the RSSI is low, then the low RSSI may be due to high propagation loss, which may be a temporarily phenomenon. However, if a packet error is detected and the RSSI is high, then the high RSSI may be due to high interference, which may be a long-term phenomenon. A Bluetooth RF channel that observes high interference may thus exhibit both high PER and high RSSI at the same time. RSSI may also be used alone or in combination with other metrics to classify Bluetooth RF channels.

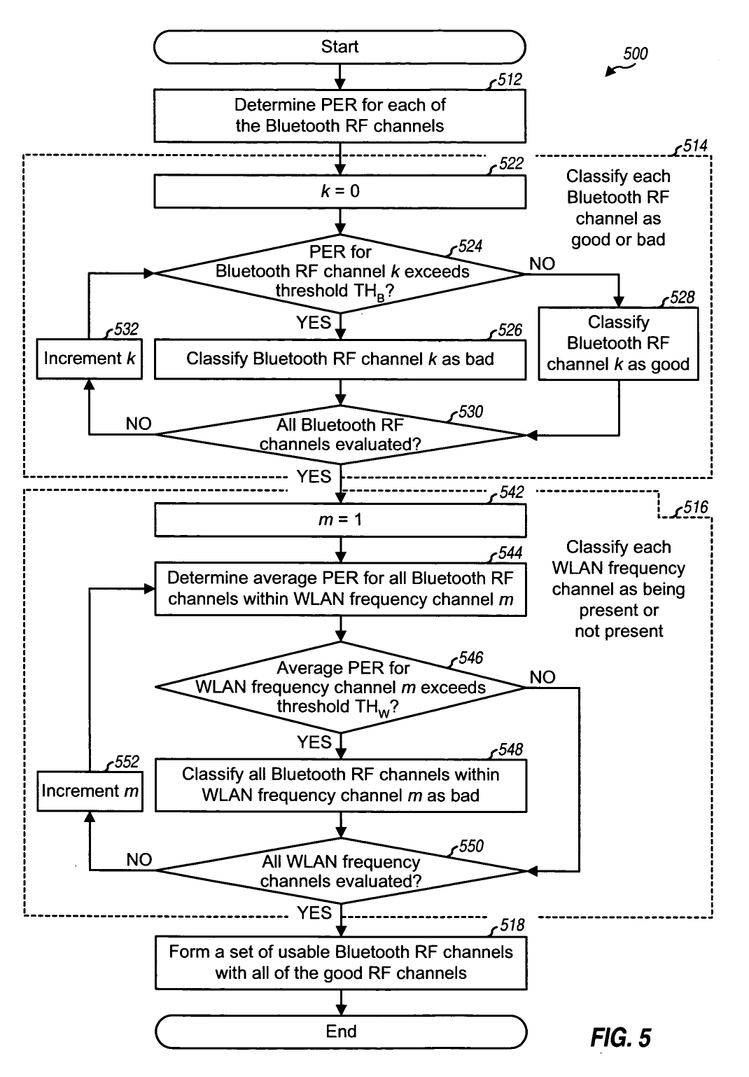

FIG. 5 shows an embodiment of a process 500 for classifying Bluetooth RF channels. Process 500 includes blocks 512, 514, 516 and 518, which are an embodiment of blocks 412, 414, 416 and 418, respectively, in FIG. 4. Process 500 performs channel classification based on PER.

Initially, the PER for each of the Bluetooth RF channels is determined (block 512). If approximately the same number of packets is sent on all Bluetooth channels over a given measurement period, then the number of packet errors for each Bluetooth RF channel may be used as the PER for that Bluetooth RF channel.

Block 514 classifies each Bluetooth RF channel as either good or bad based on the PER for that RF channel. Within block 514, an index k for Bluetooth RF channel is first initialized to zero, or k=0 (block 522). A determination is then made whether the PER for Bluetooth RF channel k exceeds a threshold TH_{B} (block 524). Bluetooth RF channel k is classified as bad if the answer is ‘Yes’ for block 524 (block 526) and is classified as good otherwise (block 528). A determination is then made whether all Bluetooth RF channels have been evaluated, or whether k=78 for the 79-hop Bluetooth system (block 530). If the answer is ‘No’, then index k is incremented (block 532), and the process returns to block 524 to evaluate the next Bluetooth RF channel. Otherwise, if all Bluetooth RF channels have been evaluated, then the process proceeds to block 516.

Block 516 determines whether excessive interference is observed on any WLAN frequency channel based on the PERs for the Bluetooth RF channels. In general, all WLAN frequency channels may be evaluated (as shown in FIG. 5) or a subset of the WLAN frequency channels may be evaluated. For example, only WLAN frequency channels 1, 6 and 11 may be evaluated since these are the more likely WLAN frequency channels.

For the embodiment shown in FIG. 5, a given WLAN frequency channel is deemed to be present and causing excessive interference to the Bluetooth system if the average PER for all Bluetooth RF channels overlapping (or within) that WLAN frequency channel exceeds a threshold TH_{W}. Within block 516, an index m for WLAN frequency channel is first initialized to one, or m=1 (block 542). The average PER for all Bluetooth RF channels within WLAN frequency channel m is then determined (block 544). The Bluetooth RF channels within WLAN frequency channels 1, 6 and 11 are shown in Table 1. The Bluetooth RF channels within other WLAN frequency channels may be determined in a similar manner. If approximately the same number of packets is sent for all Bluetooth RF channels, then the number of packet errors for all Bluetooth RF channels within WLAN frequency channel m may be summed to obtain the total number of packet errors for WLAN frequency channel m, which may be used as the average PER for WLAN frequency channel m. For example, the number of packet errors for Bluetooth RF channels 0 through 22 may be summed to obtain the total number of packet errors for WLAN frequency channel 1, the number of packet errors for Bluetooth RF channels 23 through 47 may be summed to obtain the total number of packet errors for WLAN frequency channel 6, and the number of packet errors for Bluetooth RF channels 48 through 72 may be summed to obtain the total number of packet errors for WLAN frequency channel 11.

A determination is then made whether the average PER for WLAN frequency channel m exceeds the threshold TH_{W} (block 546). If the answer is ‘Yes’, then WLAN frequency channel m is deemed to be present and causing excessive interference to the Bluetooth system. In an embodiment, all Bluetooth RF channels within detected WLAN frequency channel m are classified as bad RF channels, even if some of these Bluetooth RF channels have low PERs (block 548). If the answer is ‘No’ for block 546, then block 548 is bypassed. From blocks 546 and 548, the process proceeds to block 550.

In block 550, a determination is made whether all WLAN frequency channels have been evaluated, or whether m=11 for many countries such as the United States. If the answer is ‘No’, then index m is incremented (block 552), and the process returns to block 544 to evaluate the next WLAN frequency channel. Otherwise, if all WLAN frequency channels have been evaluated, then a set of usable Bluetooth RF channels is formed with all of the good Bluetooth RF channels (block 518).

In an embodiment, the threshold TH_{B} for the Bluetooth RF channel is an absolute value that is selected to obtain the desired performance. For example, the threshold TH_{B} may be set to achieve a target PER of 1%, 5%, or some other percentage for each Bluetooth RF channel. In another embodiment, the threshold TH_{B} is a relative value that is computed based on the metric(s) determined for the Bluetooth RF channels. For example, the threshold TH_{B} may be set equal to alpha times the average PER for all Bluetooth RF channels, where alpha may be a scaling factor that is selected to provide good performance. The threshold TH_{B} for the Bluetooth RF channel may also be defined in other manners. The threshold TH_{W} for the WLAN frequency channel may be an absolute value or a relative value.

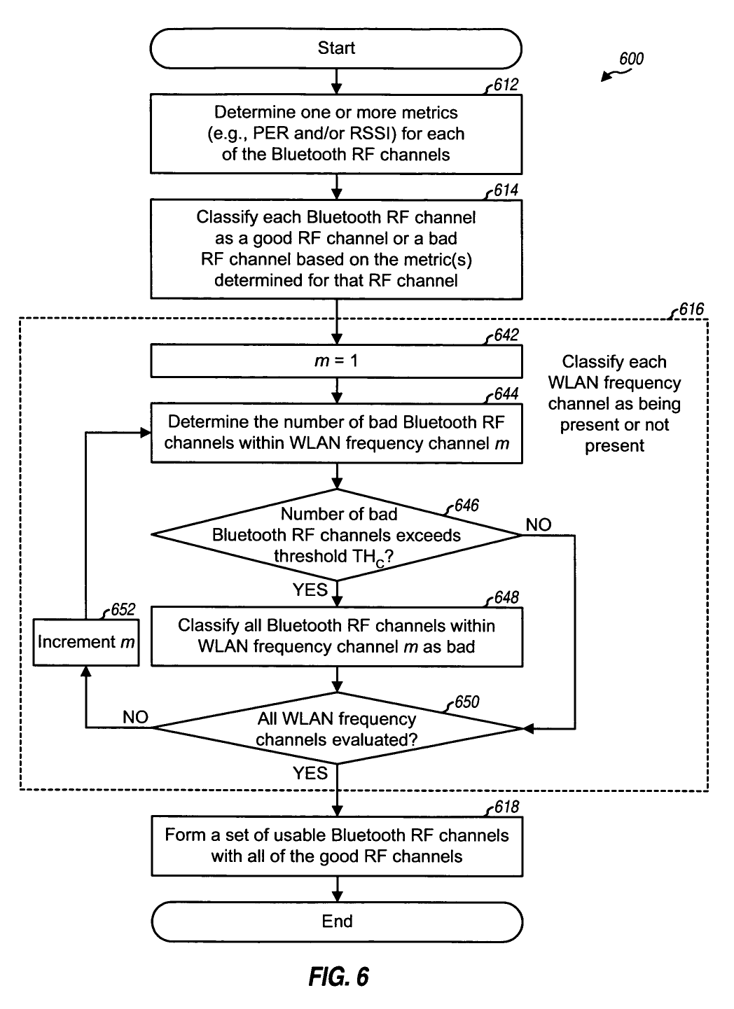

FIG. 6 shows an embodiment of a process 600 for classifying Bluetooth RF channels. Process 600 includes blocks 612, 614, 616 and 618, which are another embodiment of blocks 412, 414, 416 and 418, respectively, in FIG. 4. For process 600, one or more metrics are initially determined for each of the Bluetooth RF channels (block 612) and are used to classify each Bluetooth RF channel as either good or bad (block 614). Blocks 612 and 614 may be implemented with blocks 512 and 514, respectively, in FIG. 5.

Block 616 determines whether excessive interference is observed on any WLAN frequency channel based on the number of bad Bluetooth RF channels. All WLAN frequency channels may be evaluated (as shown in FIG. 6) or a subset of the WLAN frequency channels (e.g., channels 1, 6 and 11) may be evaluated. For the embodiment shown in FIG. 6, a given WLAN frequency channel is deemed to be present and causing excessive interference to the Bluetooth system if the number of bad Bluetooth RF channels within that WLAN frequency channel exceeds a threshold TH_{C}, which may be an absolute value or a relative value.

Within block 616, an index m for WLAN frequency channel is first initialized to one (block 642). The number of bad Bluetooth RF channels within WLAN frequency channel m is determined (block 644). A determination is then made whether the number of bad Bluetooth RF channels within WLAN frequency channel m exceeds the threshold TH_{C} (block 646). If the answer is ‘Yes’, then WLAN frequency channel m is deemed to be present and causing excessive interference to the Bluetooth system, and all Bluetooth RF channels within WLAN frequency channel m are classified as bad (block 648). Otherwise, if the number bad Bluetooth RF channels is equal to or less than the threshold TH_{C}, then block 648 is bypassed. From blocks 646 and 648, the process proceeds to block 650.

In block 650, a determination is made whether all WLAN frequency channels have been evaluated. If the answer is ‘No’, then index m is incremented (block 652), and the process returns to block 644 to evaluate the next WLAN frequency channel. Otherwise, the process proceeds to block 618 where a set of usable RF channels is formed with all of the good RF channels.

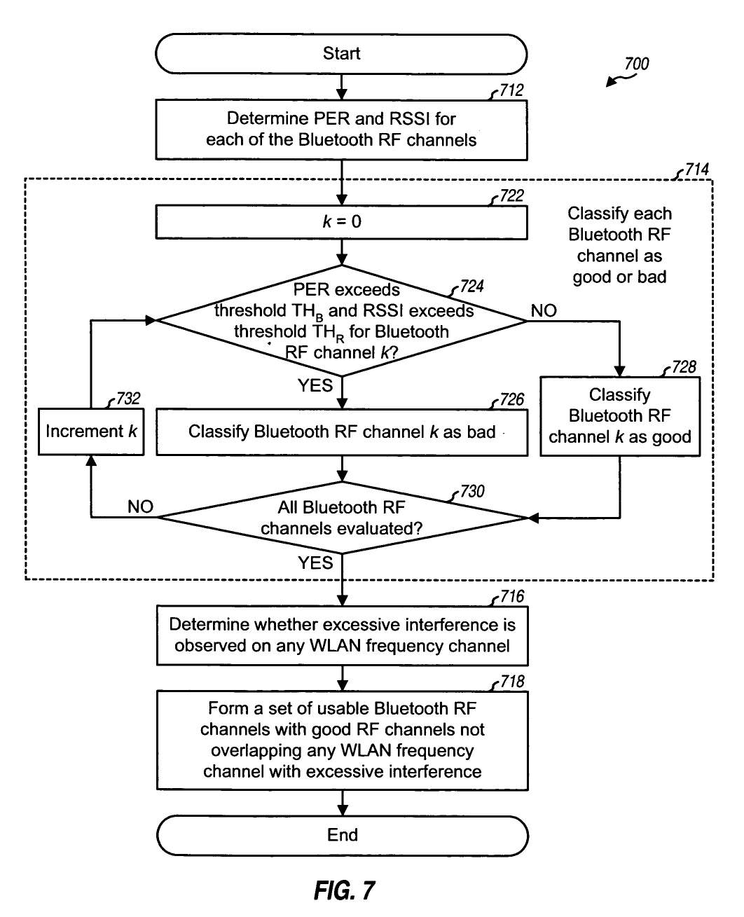

FIG. 7 shows an embodiment of a process 700 for classifying Bluetooth RF channels. Process 700 includes blocks 712, 714, 716 and 718, which are yet another embodiment of blocks 412, 414, 416 and 418, respectively, in FIG. 4. For process 700, the PER and RSSI for each of the Bluetooth RF channels are initially determined (block 712). The number of packet errors may be used for PER if approximately the same number of packets is sent on all Bluetooth RF channels in a given measurement period.

Block 714 classifies each Bluetooth RF channel as either good or bad based on the PER and RSSI for that RF channel. Within block 714, an index k for Bluetooth RF channel is first initialized to zero (block 722). A determination is then made whether the PER for Bluetooth RF channel k exceeds the threshold TH_{B} and the RSSI for Bluetooth RF channel k exceeds a threshold TH_{R} (block 724). The threshold TH_{B} may be (1) an absolute threshold or (2) a relative threshold that may be determined based on the average PER for all Bluetooth RF channels. The threshold TH_{R} may also be (1) an absolute threshold or (2) a relative threshold that may be determined based on the average RSSI for all Bluetooth RF channels. In any case, if both conditions are true and the answer is ‘Yes’ for block 724, then Bluetooth RF channel k is classified as bad (block 726). Otherwise, if the answer is ‘No’ for block 724, then Bluetooth RF channel k is classified as good (block 728). A determination is then made whether all Bluetooth RF channels have been evaluated (block 730). If the answer is ‘No’, then index k is incremented (block 732), and the process returns to block 724 to evaluate the next Bluetooth RF channel. Otherwise, the process proceeds to block 716.

In block 716, a determination is made whether excessive interference is observed on any WLAN frequency channel. Block 716 may be implemented with block 516 in FIG. 5, block 616 in FIG. 6, or in some other manner. A set of usable Bluetooth RF channels is then formed based on the good RF channels (block 718).

FIGS. 4 through 7 show specific embodiments in which the Bluetooth RF channels are classified using PER and RSSI. The Bluetooth RF channels may also be classified using other metrics such as bit error rate (BER), received signal quality, and so on.

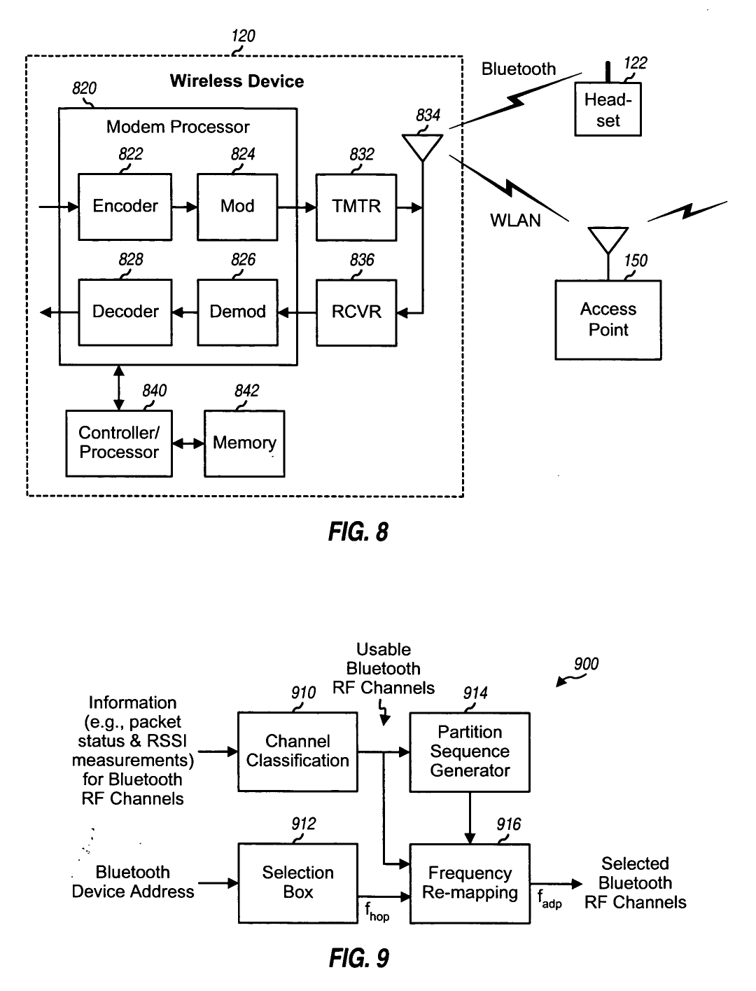

FIG. 8 shows a block diagram of an embodiment of wireless device 120, which is capable of communicating with both the Bluetooth and WLAN systems. Wireless device 120 is also capable of implementing the techniques described herein.

On the transmit path, data to be sent by wireless device 120 to a Bluetooth device or a WLAN device is processed (e.g., formatted, encoded, and interleaved) by an encoder 822 and further processed (e.g., modulated and scrambled) by a modulator (Mod) 824 to generate data chips. Modulator 824 may perform FHSS, DSSS, or OFDM modulation for WLAN and may perform frequency hopping for Bluetooth. In general, the processing by encoder 822 and modulator 824 is determined by the system for which data is sent (e.g., Bluetooth, 802.11b, 802.11g, and so on). A transmitter (TMTR) 832 conditions (e.g., converts to analog, filters, amplifies, and frequency upconverts) the data chips and generates an RF output signal, which is transmitted via an antenna 834.

On the receive path, RF signals transmitted by one or more Bluetooth devices (e.g., headset 122) and/or one or more WLAN devices (e.g., access point 150) are received by antenna 834 and provided to a receiver (RCVR) 836. Receiver 836 conditions (e.g., filters, amplifies, frequency downconverts, and digitizes) the received signal and generates data samples. A demodulator (Demod) 826 processes (e.g., descrambles and demodulates) the data samples to obtain symbol estimates. A decoder 828 processes (e.g., deinterleaves and decodes) the symbol estimates to obtain decoded data. Decoder 828 further checks each decoded packet to determine whether the packet is decoded correctly or in error. In general, the processing by demodulator 826 and decoder 828 is complementary to the processing performed by the modulator and encoder at the transmitting device. Encoder 822, modulator 824, demodulator 826 and decoder 828 may be implemented by a modem processor 820.

A controller/processor 840 directs the operation of various processing units within wireless device 120. A memory 842 stores program codes and data for wireless device 120. Controller/processor 840 may implement process 400, 500, 600 and/or 700 in FIGS. 4 through 7.

FIG. 9 shows a block diagram of an embodiment of a frequency hopping unit 900 at wireless device 120. Unit 900 may be implemented within modulator 824, controller 840, and/or some other unit at wireless device 120. Unit 900 determines the Bluetooth RF channel to use for transmission in each time slot.

Within unit 900, a channel classification unit 910 receives information used to derive one or more metrics for the Bluetooth RF channels. This information may comprise the status of each decoded packet (e.g., good or erased), received power measurements, and/or other types of information. The metric(s) may be PER, RSSI, and so on. Unit 910 determines the metric(s) for each Bluetooth RF channel based on the received information. For example, unit 910 may determine the PER or the number of packet errors for each Bluetooth RF channel based on the packet status for that RF channel. Unit 910 also performs channel classification based on the metric(s) for the Bluetooth RF channels and provides a set of usable Bluetooth RF channels. Unit 910 may implement process 400, 500, 600, 700 or some other process for the channel classification.

A selection box 912 receives a unique address for a Bluetooth device and generates a hopping sequence fₕₒₚ that selects different RF channels in different time slots. The hopping sequence fₕₒₚ assumes that all Bluetooth RF channels are usable, i.e., there are no bad RF channels. A partition sequence generator 914 generates a partition sequence that indicates whether the RF channel for the next time slot should be taken from a set of usable RF channels (S_{G}) or a set of bad RF channels to be kept (S_{BK}). A frequency re-mapping unit 916 re-maps the RF channels indicated by the hopping sequence fₕₒₚ to the RF channels in the set S_{G} or S_{BK}, if necessary, as determined by the partition sequence. Unit 916 provides a modified hopping sequence f_{adp} that selects different usable RF channels in different time slots. The operation of selection box 912 is described in IEEE 802.15.1 standard, which is publicly available. The operation of partition sequence generator 914 and frequency re-mapping unit 916 is described in IEEE 802.15.2 standard, which is also publicly available.

The channel classification techniques described herein may speed up the identification of interferers that operate on static frequency bands. These interferers may be WLAN systems or some other systems.

For clarity, the channel classification techniques have been specifically described for Bluetooth and WLAN systems. In general, these techniques may be used for any communication system in which a transmission may be sent on either the entire system bandwidth or selected portions of the system bandwidth. For example, the techniques may be used for an orthogonal frequency division multiple access (OFDMA) system that utilizes OFDM, a single-carrier frequency division multiple access (SC-FDMA) system, other OFDM-based systems, and so on. OFDM is a multi-carrier modulation technique that partitions the overall system bandwidth into multiple (K) orthogonal subbands. These subbands are also called tones, subcarriers, bins, and so on. With OFDM, each subband is associated with a respective subcarrier that may be modulated with data. An SC-FDMA system may utilize interleaved FDMA (IFDMA) to transmit on subbands that are distributed across the system bandwidth, localized FDMA (LFDMA) to transmit on a block of adjacent subbands, or enhanced FDMA (EFDMA) to transmit on multiple blocks of adjacent subbands. In general, modulation symbols are sent in the frequency domain with OFDM and in the time domain with SC-FDMA. The channel classification techniques may be used to classify each subband as either good or bad, and the good subbands may be used for transmission. The techniques may be used for systems with frequency hopping and systems without frequency hopping.

The channel classification techniques described herein may be implemented by various means. For example, these techniques may be implemented in hardware, firmware, software, or a combination thereof. For a hardware implementation, the processing units used to perform channel classification may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, and so on) that perform the functions described herein. The software codes may be stored in a memory (e.g., memory 842 in FIG. 8) and executed by a processor (e.g., processor 840). The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
at least one processor configured
to determine at least one metric for radio frequency (RF) channels in a first communication system,
to determine whether excessive interference is observed on any frequency channel for a second communication system based on the at least one metric for the RF channels in the first system, and
to form a set of usable RF channels for the first system, wherein the set excludes RF channels that overlap any frequency channel with excessive interference; and
a memory coupled to the at least one processor.

2. The apparatus of claim 1, wherein the at least one processor is configured to determine a packet error rate (PER) for each of the RF channels.

3. The apparatus of claim 1, wherein the at least one processor is configured to determine a received signal strength indication (RSSI) for each of the RF channels.

4. The apparatus of claim 1, wherein the first system implements Bluetooth, and wherein the second system implements an IEEE 802.11 standard.

5. The apparatus of claim 1, wherein the at least one processor is configured to classify each of the RF channels as a good RF channel or a bad RF channel based on the at least one metric for the RF channel.

6. The apparatus of claim 1, wherein the at least one processor is configured to classify each of the RF channels as a bad RF channel if a packet error rate (PER) for the RF channel exceeds a threshold and as a good RF channel otherwise.

7. The apparatus of claim 6, wherein the at least one processor is configured to set the threshold to a predetermined value.

8. The apparatus of claim 6, wherein the at least one processor is configured to set the threshold based on an average PER for the RF channels.

9. The apparatus of claim 1, wherein the at least one processor is configured to classify each of the RF channels as a good RF channel or a bad RF channel based on a packet error rate (PER) and a received signal strength indication (RSSI) for the RF channel.

10. The apparatus of claim 9, wherein for each of the RF channels the at least one processor is configured
to classify the RF channel as a bad RF channel if the PER for the RF channel exceeds a first threshold and the RSSI for the RF channel exceeds a second threshold, and
to classify the RF channel as a good RF channel otherwise.

11. The apparatus of claim 10, wherein the at least one processor is configured to set the second threshold based on an average RSSI for the RF channels.

12. The apparatus of claim 1, wherein the at least one processor is configured to determine whether excessive interference is observed on each of at least one frequency channel for the second system based on an average packet error rate (PER) for RF channels overlapping the frequency channel.

13. The apparatus of claim 5, wherein the at least one processor is configured to determine whether excessive interference is observed on each of at least one frequency channel for the second system based on the number of bad RF channels within the frequency channel.

14. The apparatus of claim 4, wherein the at least one processor is configured to determine whether excessive interference is observed on each of frequency channels 1, 6 and 11 for the second system based on the at least one metric for the RF channels.

15. The apparatus of claim 1, wherein the at least one processor is configured to modify a hopping sequence for the first system to hop across the set of usable RF channels and to avoid other RF channels excluded from the set.

16. A method comprising:
determining at least one metric for radio frequency (RF) channels in a first communication system;
determining whether excessive interference is observed on any frequency channel for a second communication system based on the at least one metric for the RF channels in the first system; and
forming a set of usable RF channels for the first system, wherein the set excludes RF channels that overlap any frequency channel with excessive interference.

17. The method of claim 16, further comprising:
classifying each of the RF channels as a good RF channel or a bad RF channel based on the at least one metric for the RF channel.

18. The method of claim 17, wherein the determining whether excessive interference is observed on any frequency channel comprises
determining whether excessive interference is observed on each of at least one frequency channel for the second system based on the number of bad RF channels within the frequency channel.

19. The method of claim 16, wherein the determining whether excessive interference is observed on any frequency channel comprises
determining whether excessive interference is observed on each of at least one frequency channel for the second system based on an average packet error rate (PER) for RF channels overlapping the frequency channel.

20. An apparatus comprising:
means for determining at least one metric for radio frequency (RF) channels in a first communication system;
means for determining whether excessive interference is observed on any frequency channel for a second communication system based on the at least one metric for the RF channels in the first system; and
means for forming a set of usable RF channels for the first system, wherein the set excludes RF channels that overlap any frequency channel with excessive interference.

21. The apparatus of claim 20, further comprising:
means for classifying each of the RF channels as a good RF channel or a bad RF channel based on the at least one metric for the RF channel.

22. The apparatus of claim 21, wherein the means for determining whether excessive interference is observed on any frequency channel comprises
means for determining whether excessive interference is observed on each of at least one frequency channel for the second system based on the number of bad RF channels within the frequency channel.

23. The apparatus of claim 20, wherein the means for determining whether excessive interference is observed on any frequency channel comprises
means for determining whether excessive interference is observed on each of at least one frequency channel for the second system based on an average packet error rate (PER) for RF channels overlapping the frequency channel.

24. A processor readable media for storing instructions operable in a wireless device to:
determine at least one metric for radio frequency (RF) channels in a first communication system;
determine whether excessive interference is observed on any frequency channel for a second communication system based on the at least one metric for the RF channels in the first system; and
form a set of usable RF channels for the first system, wherein the set excludes RF channels that overlap any frequency channel with excessive interference.

25. The processor readable media of claim 24, and further for storing instructions operable to:
classify each of the RF channels as a good RF channel or a bad RF channel based on the at least one metric for the RF channel.

26. The processor readable media of claim 25, and further for storing instructions operable to:
determine whether excessive interference is observed on each of at least one frequency channel for the second system based on the number of bad RF channels within the frequency channel.

27. The processor readable media of claim 24, and further for storing instructions operable to:
determine whether excessive interference is observed on each of at least one frequency channel for the second system based on an average packet error rate (PER) for RF channels overlapping the frequency channel.
